(19) United States
(12) Patent Application Publication
(10) Pub. No.: US 2013/0328500 A1
(43) Pub. Date: Dec. 12, 2013

(54) ILLUMINATION CONTROLLER AND ILLUMINATION SYSTEM INCLUDING SAME

(71) Applicant: Panasonic Corporation, Osaka (JP)

(72) Inventor: Naohiro TODA, Osaka (JP)

(73) Assignee: Panasonic Corporation, Osaka (JP)

(21) Appl. No.: 13/905,272

(22) Filed: May 30, 2013

(30) Foreign Application Priority Data
Jun. 7, 2012 (JP) 2012-130179

(51) Int. Cl. H05B 37/02

(52) U.S. Cl. CPC H05B 37/0209
USPC 315/292

(57) ABSTRACT

An illumination controller, which is configured to control a light source unit, includes: a dial, which is rotatable, used to adjust a color temperature and a quantity of light irradiated from the light source unit, a memory which stores one or more control curves in which the color temperature and the quantity of light irradiated from the light source unit change in conjunction with each other; and a curve selection unit used to select one curve among the control curves stored in the memory. When the dial is rotated, the color temperature and the quantity of light irradiated from the light source unit change according to values defined on the control curve selected by the curve selection unit.

### FIELD OF THE INVENTION

The present invention relates to an illumination controller which controls a light source to change a color temperature and a quantity of light irradiated from the light source, and an illumination system including the same.

### BACKGROUND OF THE INVENTION

A color temperature and a quantity of light irradiated from a light source have many effects on human psychology. Through many experiments, it has been reported that there is a relationship between the color temperature and the quantity of the irradiated light and human psychology thereunder. Especially, the idea that “upper and lower limits of comfortable illuminance (quantity of light) vary depending on the color temperature” showed by Kruithof in 1941 is widely accepted.

As shown in FIG. 7, according to the experiments of Kruithof, a high color temperature light (e.g., pale light emitted from a daylight white fluorescent lamp, color temperature: ˜5000 K) gives off a refreshing impression to people in a case of high illuminance, but a dismal impression to people in a case of low illuminance. Contrarily, a low color temperature light (e.g., reddish light emitted from an incandescent lamp, color temperature: ˜2800 K) gives off a sultry impression to people in a case of high illuminance, but a gentle impression to people if it is adjusted to moderate illuminance. Thus, an illuminance which makes people feel comfortable or uncomfortable varies depending on the color temperature of the irradiated light.

In recent years, an illumination apparatus, which changes the color temperature of the irradiated light by combining light emitting diodes (LEDs) that emit red, green, and blue light, respectively, has been known. As an illumination apparatus of this type, for example, Japanese Patent Laid-open Publication No. 2009-117080 discloses an apparatus in which the quantity and the color temperature of irradiated light are changed only in the region where people feel comfortable, as shown in FIG. 7.

However, in the illumination apparatus described above, since the quantity and the color temperature of the irradiated light are adjusted manually, it is difficult for general users, who do not have expertise in illumination, to adjust the quantity and the color temperature of the irradiated light while keeping a good balance thereof. Also, it is difficult for general users to set them according to the illumination environment such as a location or a time zone in which the illumination apparatus is used.

### SUMMARY OF THE INVENTION

In view of the above, the present invention provides an illumination controller that even general users can use to adjust a quantity and a color temperature of light irradiated from a light source while keeping a good balance thereof and easily to set them according to the illumination environment, and an illumination system including the same.

In accordance with a first aspect of the present invention, there is provided an illumination controller, which controls a light source unit having a plurality of light sources that emit different colored lights, including: a dial, which is rotatable, used to adjust a color temperature and a quantity of light irradiated from the light source unit, a memory which stores one or more control curves in which the color temperature and the quantity of light irradiated from the light source unit change in conjunction with each other; and a curve selection unit used to select one curve among the control curves stored in the memory, wherein when the dial is rotated, the color temperature and the quantity of light irradiated from the light source unit change according to values defined on the control curve selected by the curve selection unit.

The curve selection unit may include one or more curve selection buttons used to select one control curve among the control curves.

Further, the dial may be formed of a disc-shaped knob which is adapted to be pressed in a direction perpendicular to a rotational plane of the dial. Accordingly, the dial may function as the curve selection unit when it is pressed.

The controller may further include a display unit configured to indicate a currently selected control curve.

In accordance with a second aspect of the present invention, there is provided an illumination system including the illumination controller as described above.

The illumination system may further include a timer configured to start and terminate an operation of the controller at a preset time.

The control curves preferably include a normal mode curve in which a variation width of the quantity of light to a variation width of the color temperature is large in a low color temperature range, and is small in a high color temperature range.

The control curves may further include a wakeup mode curve in which each of the quantity of light and the color temperature increases monotonically with the time at wakeup time.

Furthermore, the control curves may include a bedtime mode curve in which the quantity of light rises as the color temperature of light increases in a low color temperature range, while the color temperature of light is prevented from becoming a high color temperature.

According to the present invention, since the quantity and the color temperature of the irradiated light change changed according to the control curve in which the color temperature and the quantity of the irradiated light vary in conjunction with each other, even general users can adjust the quantity and the color temperature of the irradiated light while keeping a good balance thereof. Further, since a plurality of control curves are provided, it is possible to easily set the quantity and the color temperature of light by appropriately selecting the control curve proper to the illumination environment.

### BRIEF DESCRIPTION OF THE DRAWINGS

The objects and features of the present invention will become apparent from the following description of embodiments, given in conjunction with the accompanying drawings, in which:

FIG. 1 is a configuration diagram of an illumination system in accordance with an embodiment of the present invention;

FIG. 2A is a block diagram of a power source unit included in the illumination system, and FIG. 2B is a circuit diagram of a drive unit provided in the power source unit;

FIG. 3 shows control curves used to adjust the color temperature and the quantity of irradiation light in the illumination system;

FIG. 4 is a view for explaining rotation of a dial provided in a controller of the illumination system;

FIGS. 5A and 5B are a front view and a side view of a controller in the illumination system according to a first modification of the embodiment, respectively;

FIG. 6 is a configuration diagram of an illumination system according to a second modification of the embodiment; and

FIG. 7 is a diagram showing a relationship between a color temperature and an illuminance of irradiation light, and the impression that people receive therefrom.

### DETAILED DESCRIPTION OF THE EMBODIMENTS

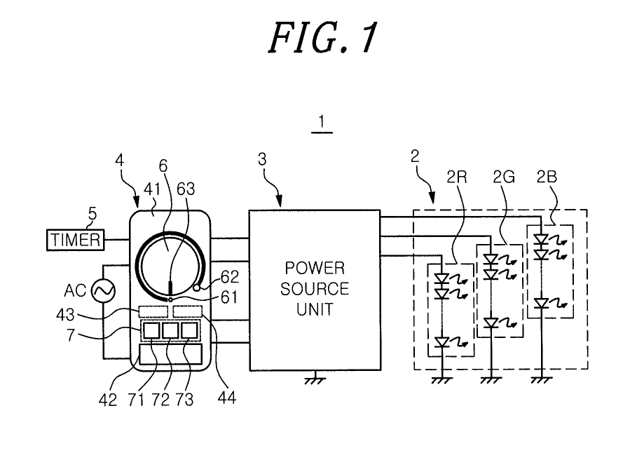

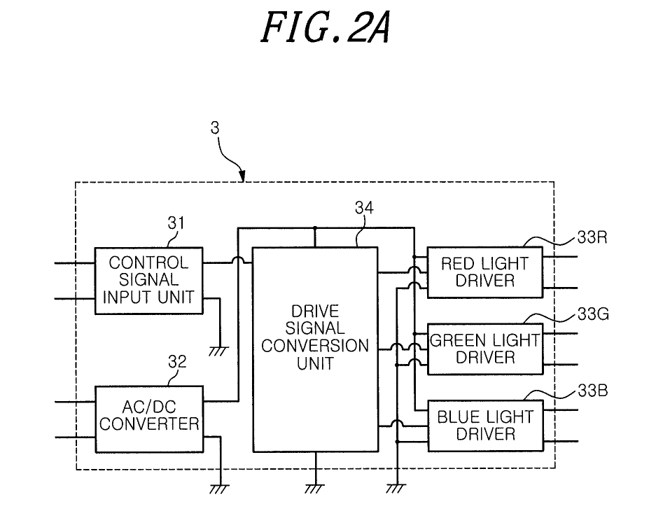

A color temperature variable illumination system (hereinafter, referred to as an illumination system) in accordance with an embodiment of the present invention will be described with reference to FIGS. 1 to 4.

As shown in FIG. 1, an illumination system 1 according to the present embodiment includes a light source unit 2, a power source unit 3 for supplying a power to the light source unit 2, and a controller 4 for controlling an operation of the power source unit 3 in response to an input from a user. Further, the illumination system 1 includes a timer 5 for starting and terminating an operation of the controller 4 at a predetermined time. The timer 5 is configured such that the current time, and the operation start time and operation end time of the controller 4 can be set. Accordingly, the timer 5 controls the operation of the controller 4 by transmitting a trigger signal to the controller 4 when it reaches a specified time.

The light source unit 2 has multiple types of light sources that emit different colored lights. In the present embodiment, the light source unit 2 has a red light source 2R (R: Red) that emits red light, a green light source 2G (G: Green) that emits green light, and a blue light source 2B (B: Blue) that emits blue light. The red light source 2R is constituted by a plurality of red LEDs connected in series to each other. The green light source 2G is constituted by a plurality of green LEDs connected in series to each other. The blue light source 2B is constituted by a plurality of blue LEDs connected in series to each other.

The controller 4 includes a housing 41 which is fixed to, e.g., a wall surface of a room where the illumination system 1 is installed. The housing 41 has a rectangular box shape. Provided on one surface of the housing 41 are a power switch 42 for turning on and off the light source unit 2, and a rotatable dial 6 used to adjust a color temperature and a quantity of the light emitted from the light source unit 2. Further, a plurality of marks 61 and 62 is provided to indicate a rotation location of the dial 6. The power switch 42 is formed of a push-button switch that opens and closes a circuit supplying power from an alternating current power source (AC) to the power source unit 3. When the dial 6 is likened to a clock, the marks 61 and 62 are provided at 6 o'clock and 4 o'clock positions around the dial 6, respectively.

The dial 6 is provided as a disc-shaped knob, and has a marking 63 for indicating its own rotational position on the surface thereof. The dial 6 rotates within a certain range, and upper and lower limits of the color temperature and the quantity of irradiation light are set within this rotation range. In the present embodiment, the dial 6 is configured such that the marking 63 is rotatable by approximately 300° between the mark 61 and the mark 62. When the marking 63 meets the mark 61, the quantity and the color temperature of light irradiated from the light source unit 2 become the minimum. Further, when the marking 63 meets the mark 62, the quantity and the color temperature of irradiation light from the light source unit 2 become the maximum. The dial 6 may be configured to be rotated smoothly or may be configured to click when it is rotated.

Further, the controller 4 includes a memory 43 for storing a plurality of control curves defined such that the color temperature and the quantity of irradiation light changes in conjunction with each other, and a curve selection unit 7 for selecting one curve among the control curves stored in the memory 43. In the present embodiment, the curve selection unit 7 includes three curve selection buttons 71, 72 and 73. The control curves and the curve selection unit 7 will be described later in detail. Further, the controller 4 has a control unit 44 for generating a control signal to control the light source unit 2 in response to an input from the user.

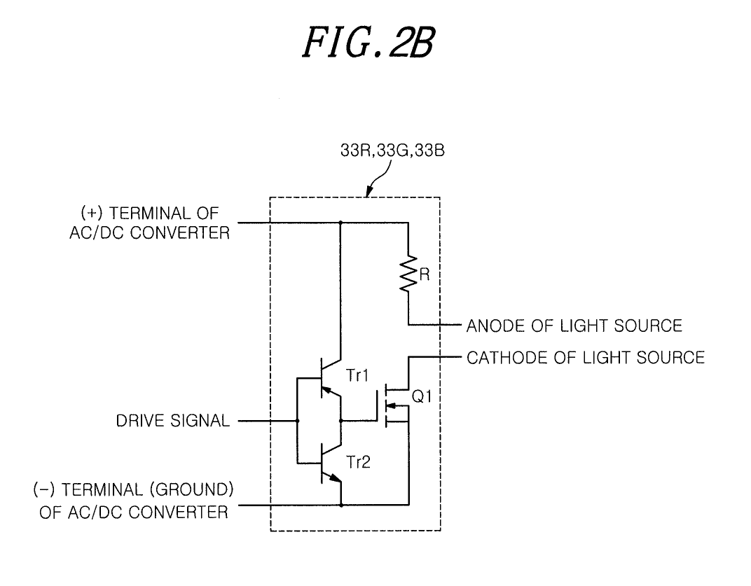

Referring to FIG. 2A, the power source unit 3 includes a control signal input unit 31 to which a control signal generated by the control unit 44 is inputted, and an AC/DC converter 32 which converts an AC voltage, supplied from the AC power source through the controller 4, into a desired DC voltage. Further, the power source unit 3 includes a red light driver 33R for driving the red light source 2R, a green light driver 33G for driving the green light source 2G, and a blue light driver 33B for driving the blue light source 2B. Furthermore, the power source unit 3 includes a drive signal conversion unit 34 that converts the control signal inputted through the control signal input unit 31 into a drive signal for driving each of the drivers 33R, 33G, and 33B. The drive signal conversion unit 34 outputs a drive signal of a square wave signal having a variable on-duty ratio and a predetermined period.

The drivers 33R, 33G and 33B have the same configuration. As shown in FIG. 2B, each of the drivers 33R, 33G, and 33B has a resistor R as a current limiter, and the resistor R is inserted between the anode of each of the light sources 2R, 2G and 2B and the positive (+) terminal of the AC/DC converter 32. Further, each of the drivers 33R, 33G and 33B has a switching element Q1 which is connected to the cathode of each of the light sources 2R, 2G, and 2B, and the drain of the switching element Q1 is connected to the negative (−) terminal (ground) of the AC/DC converter 32. The switching element Q1 is formed of a field effect transistor.

Further, each of the drivers 33R, 33G and 33B has a waveform shaping circuit including two transistors Tr1 and Tr2 connected in parallel to each other. The transistor Tr1 is constituted by a PNP bipolar transistor having a collector connected to the positive (+) terminal of the AC/DC converter 32 and an emitter connected to the gate of the switching element Q1. The transistor Tr2 is constituted by an NPN bipolar transistor having a collector connected to the gate of the switching element Q1 and an emitter connected to the negative (−) terminal of the AC/DC converter 32. The waveform shaping circuit performs pulse width modulation (PWM) control on the switching element Q1 based on a drive signal inputted to bases of the transistors Tr1 and Tr2 from the drive signal conversion unit 34, thereby adjusting the amount of power supplied to each of the light sources 2R, 2G, and 2B.

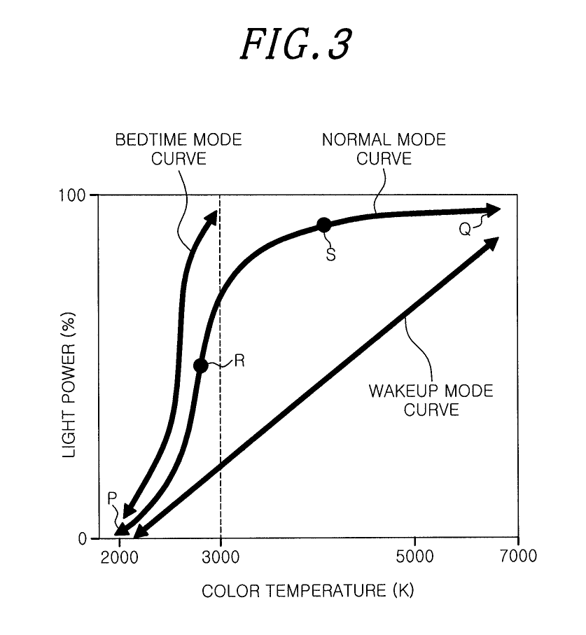

In the illumination system 1 as described above, when rotating the dial 6 of the controller 4, the color temperature and the quantity of light irradiated from the light source unit 2 change according to the values determined by one of the plurality of control curves. As shown in FIG. 3, the plurality of control curves include at least one of, e.g., a normal mode curve used in a normal state, a wakeup mode curve used at wakeup time, and a bedtime mode curve used at bedtime. The normal mode curve, the wakeup mode curve and the bedtime mode curve are assigned to the curve selection buttons 71, 72, and 73, respectively, and each curve can be selected by pressing the corresponding button. In FIG. 3, the light power is represented as a percentage to the maximum power of the light source unit 2.

The normal mode curve is defined such that a variation width of a light power (i.e., quantity of light) to a variation width of the color temperature is great in a low color temperature range (<3000 K), and small in a high color temperature range (≧3000 K). Normally, a rated power of light is sufficient for normal use in a high color temperature range, and increasing the quantity of light is undesirable from an energy saving point of view. Therefore, in the normal mode curve, an increase of the light power (quantity of light) is suppressed in the high color temperature range. By using the normal mode curve, it is possible to reduce the power consumption of the light source unit 2 while preferably keeping a balance between the color temperature and the quantity of irradiation light.

The wakeup mode curve is defined such that both of the quantity and the color temperature of irradiation light increase monotonically with the time at wakeup time. Since the color temperature and the quantity of irradiation light gradually increase, the user can wake up pleasantly without an uncomfortable feeling. In this case, the illumination system 1 is started at a preset time by the timer 5.

The bedtime mode curve is defined such that a variation width of a light power (quantity of light) to a variation width of the color temperature is large in a low color temperature range (<3000 K), while the color temperature of the irradiation light is prevented from becoming a high color temperature (>3000 K). It is known that melatonin, which is a hormone that promotes sleep, is secreted from the pineal gland in the brain at bedtime, and that this secretion of melatonin is suppressed by blue light (light of a high color temperature). Thus, by irradiating light in accordance with the bedtime mode curve at bedtime, illumination can be achieved with a sufficient quantity of light when reading a book before going asleep, without interfering with the onset of sleep.

In the present embodiment, the control curves are defined such that the color temperature and the quantity of irradiation light change in conjunction with each other in a region where people feel comfortable, which is known by Kruithof's experiments. Thus, it is possible to always obtain the irradiation light which makes the user feel comfortable, while keeping a good balance between the color temperature and the quantity of irradiation light.

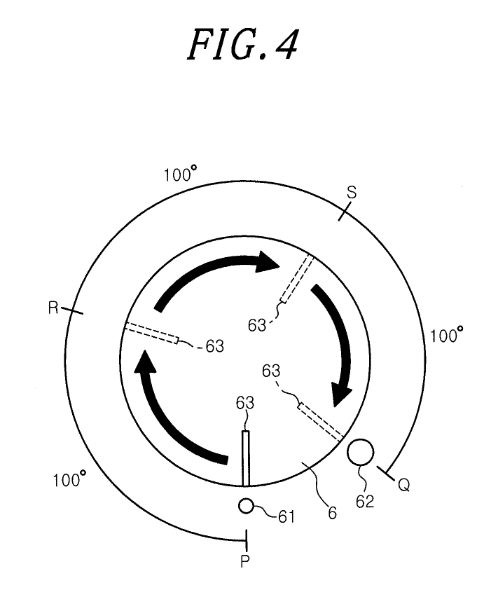

In adjusting the color temperature and the quantity of irradiation light, the control unit 44 of the controller 4 determines variations in the color temperature and the quantity of light by associating the rotational angle of the dial 6 with the length on the corresponding control curve. This mechanism will be described with reference to FIGS. 3 and 4 by using the normal mode curve as an example.

As described above, the dial 6 is configured such that the marking 63 is rotatable by approximately 300° between the mark 62 and the mark 61 (see FIG. 4). The color temperature and the quantity of irradiation light when the marking 63 of the dial 6 meets the mark 61, correspond to values defined by end point P (see FIG. 3) on the side of the low light power (low quantity of light) and the low color temperature of the normal mode curve. Further, the color temperature and the quantity of irradiation light when the marking 63 of the dial 6 meets the mark 62, correspond to values defined by end point Q on the side of the high light power (high quantity of light) and the high color temperature of the normal mode curve. Hereinafter, the length between two end points P and Q on the normal mode curve is referred to as L.

When the dial 6 is rotated by approximately 100° (⅓ of the total rotation) from the state where the marking 63 meets the mark 61, values defined at point R moved by the amount of (⅓)L toward the side of the high light power (high quantity of light) and the high color temperature from the end point P on the normal mode curve are assigned as the color temperature and the quantity of irradiation light.

Then, when the dial 6 is further rotated by 100° (rotated by 200° in total from the mark 61, ⅔ of the total rotation), values defined at point S further moved by the amount of (⅓)L toward the side of the high light power and the high color temperature from the point R on the normal mode curve are assigned as the color temperature and the quantity of irradiation light.

In this way, by associating the rotational angle of the dial 6 with the length of the control curve, the rotational angle of the dial 6 can be corresponded to the variations in the color temperature and the quantity of irradiation light. Thus, it is possible to smoothly adjust the color temperature and the quantity of irradiation light. Particularly, it facilitates fine adjustment of the light power (quantity of light) and the color temperature in a region (near the point R of FIG. 3) where the variation width of the light power to the variation width of the color temperature is large in the control curve, or a region (near the point S of FIG. 3) where the variation width of the color temperature to the variation width of the light power is large.

With the illumination system 1 of the present embodiment as described above, since the color temperature and the quantity of irradiation light change according to the corresponding control curve, even users who do not have expertise in illumination can adjust the color temperature and the quantity of irradiation light while keeping a good balance therebetween. Further, since a plurality of control curves are provided, it is possible to easily set the color temperature and the quantity of irradiation light, by appropriately selecting the control curve according to the illumination environment such as a location or time zone using the illumination system 1.

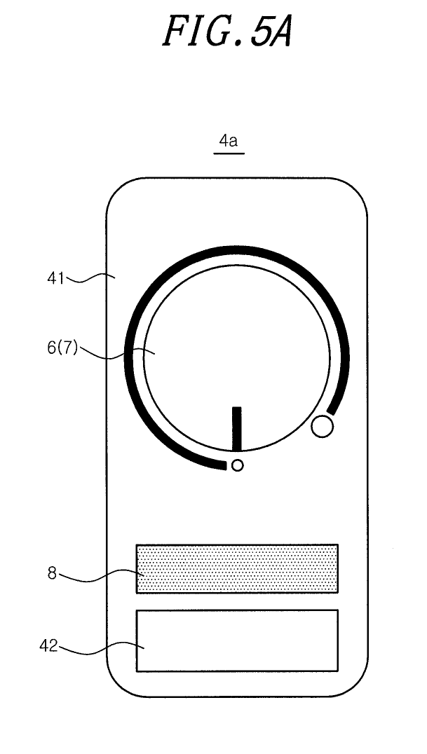

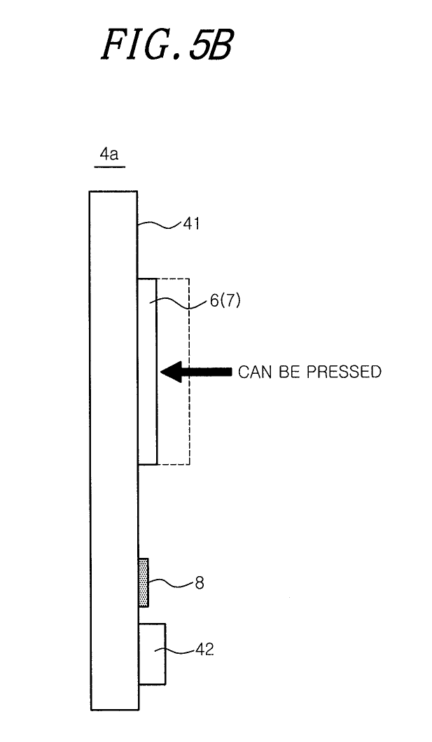

Next, a controller according to a first modification of the above embodiment will be described with reference to FIGS. 5A and 5B. In a controller 4a of this modification, unlike the above-mentioned controller 4, a display unit 8 showing a control curve, which is currently selected, is provided instead of the curve selection buttons 71 to 73 as the curve selection unit 7. The display unit 8 has, e.g., light emitters that emit multiple different colored lights, and notifies the user of the currently selected control curve, by using an emission pattern of the light emitters. Alternatively, the display unit 8 may have a liquid crystal panel, and may display the name or the curve shape of the currently selected control curve, or the like, on the liquid crystal panel. Thus, the user can easily know which control curve is being currently selected.

Further, in the controller 4a, the dial 6 is configured to be rotatable and pressed in a direction perpendicular to the rotational plane. Accordingly, the dial 6 is rotated to adjust the color temperature and the quantity of irradiation light and is pressed to function as the curve selection unit. Specifically, the dial 6 is configured such that, whenever it is pressed, the control curve is changed in the order of, e.g., the normal mode curve→the wakeup mode curve→the bedtime mode curve. In this way, since the dial 6 can also be used as the curve selection unit, the number of components constituting the controller 4a becomes fewer, and assembly efficiency of the controller 4a is improved. Further, appearance of the controller 4a is simplified and improved.

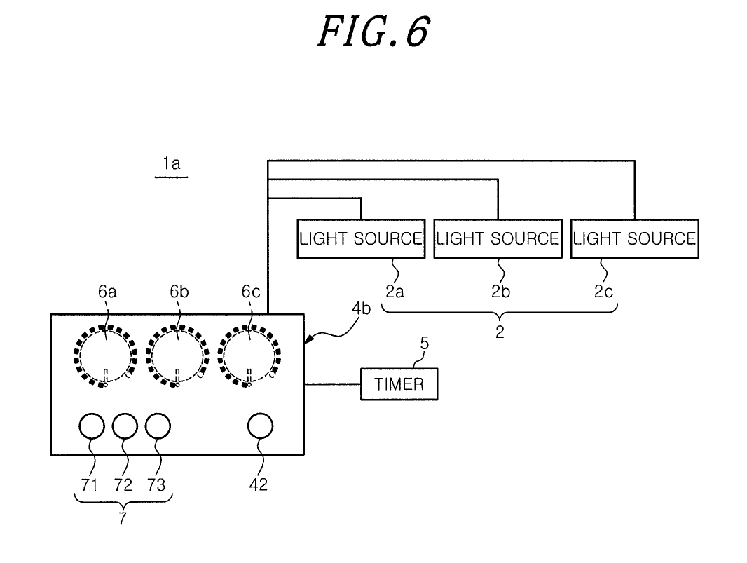

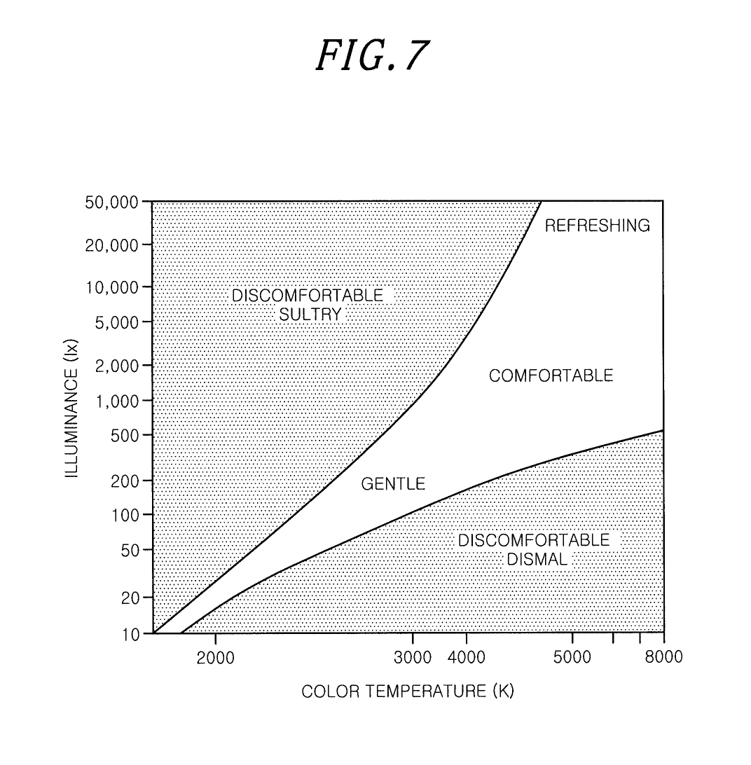

Next, an illumination system according to a second modification of the above embodiment will be described with reference to FIG. 6. An illumination system 1a of this modification includes a light source unit 2 having multiple light sources. Further, a controller 4b is provided to collectively control the color temperature and the quantity of light irradiated from the light source unit 2. Each of the light sources includes an internal power source unit (not shown) for driving itself. The light source unit 2 includes three light sources 2a, 2b, and 2c in the illustrated example; and the light sources may be identical to each other, or different from each other.

The controller 4b has a dial 6a for adjusting the light irradiated from the light source 2a, a dial 6b for adjusting the light irradiated from the light source 2b, and a dial 6c for adjusting the light irradiated from the light source 2c. When rotating each of the dials 6a, 6b and 6c, the color temperature and the quantity of irradiation light from each of the light sources 2a, 2b and 2c are changed to the values determined by the control curve selected by one of the curve selection buttons 71, 72, and 73.

With the illumination system 1a of the present modification, the characteristics of light irradiated from the light sources 2a, 2b and 2c are independently controlled by dials 6a, 6b, and 6c. However, the manner of control is not limited thereto, and it may be configured such that, for example, the dial 6a is used as a parent dial and the dials 6b and 6c are interlinked with the dial 6a. Thus, the characteristics of light irradiated from the light sources 2a, 2b and 2c can be controlled collectively by rotating the dial 6a.

As the above, the illumination controller according to the present invention and the illumination system using the same are described, but various modifications can be made without being limited to the above embodiment and its modifications. For example, the present illumination system may not have the timer. Further, the control curves and the number of the control curves are not limited to the above-described three curves. For example, the number of the control curves may be one, two, four or more, and other curves for adjusting according to another illumination environment may be used as the control curves. Furthermore, the controller may further include an adjustment button to fine-tune the control curve, and may adjust the color temperature and the quantity of irradiation light by fine-tuning the control curve using the adjustment button.

While the invention has been shown and described with respect to the embodiments, it will be understood by those skilled in the art that various changes and modification may be made without departing from the scope of the invention as defined in the following claims.

What is claimed is:

1. An illumination controller, which controls a light source unit having a plurality of light sources that emit different colored lights, comprising:
a dial, which is rotatable, used to adjust a color temperature and a quantity of light irradiated from the light source unit,
a memory which stores one or more control curves in which the color temperature and the quantity of light irradiated from the light source unit change in conjunction with each other; and
a curve selection unit used to select one curve among the control curves stored in the memory,
wherein when the dial is rotated, the color temperature and the quantity of light irradiated from the light source unit change according to values defined on the control curve selected by the curve selection unit.

2. The controller of claim 1, wherein the curve selection unit includes one or more curve selection buttons used to select one control curve among the control curves.

3. The controller of claim 1, wherein the dial is formed of a disc-shaped knob which is adapted to be pressed in a direction perpendicular to a rotational plane of the dial, and functions as the curve selection unit when it is pressed.

4. The controller of claim 2, further comprising a display unit configured to indicate a currently selected control curve.

5. The controller of claim 3, further comprising a display unit configured to indicate a currently selected control curve.

6. An illumination system including the illumination controller described in claim 1.

7. The system of claim 6, further comprising a timer configured to start and terminate an operation of the controller at a preset time.

8. The system of claim 6, wherein the control curves include a normal mode curve in which a variation width of the quantity of light to a variation width of the color temperature is large in a low color temperature range, and is small in a high color temperature range.

9. The system of claim 7, wherein the control curves include a normal mode curve in which a variation width of the quantity of light to a variation width of the color temperature is large in a low color temperature range, and is small in a high color temperature range.

10. The system of claim 8, wherein the control curves further include a wakeup mode curve in which each of the quantity of light and the color temperature increases monotonically with the time at wakeup time.

11. The system of claim 6, wherein the control curves include a wakeup mode curve in which each of the quantity of light and the color temperature increases monotonically with the time at wakeup time.

12. The system of claim 7, wherein the control curves include a wakeup mode curve in which each of the quantity of light and the color temperature increases monotonically with the time at wakeup time.

13. The system of claim 6, wherein the control curves include a bedtime mode curve in which the quantity of light rises as the color temperature of light increases in a low color temperature range, while the color temperature of light is prevented from becoming a high color temperature.

14. The system of claim 7, wherein the control curves include a bedtime mode curve in which the quantity of light rises as the color temperature of light increases in a low color temperature range, while the color temperature of light is prevented from becoming a high color temperature.

15. The system of claim 11, wherein the control curves further include a bedtime mode curve in which the quantity of light rises as the color temperature of light increases in a low color temperature range, while the color temperature of light is prevented from becoming a high color temperature.

16. The system of claim 12, wherein the control curves further include a bedtime mode curve in which the quantity of light rises as the color temperature of light increases in a low color temperature range, while the color temperature of light is prevented from becoming a high color temperature.

17. The system of claim 8, wherein the control curves further include a bedtime mode curve in which the quantity of light rises as the color temperature of light increases in the low color temperature range, while the color temperature of light is prevented from becoming a high color temperature.

18. The system of claim 9, wherein the control curves further include a bedtime mode curve in which the quantity of light rises as the color temperature of light increases in the low color temperature range, while the color temperature of light is prevented from becoming a high color temperature.

19. The system of claim 10, wherein the control curves further include a bedtime mode curve in which the quantity of light rises as the color temperature of light increases in the low color temperature range, while the color temperature of light is prevented from becoming a high color temperature.
